(19) United States
(12) Patent Application Publication
(10) Pub. No.: US 2020/0031274 A1
(43) Pub. Date: Jan. 30, 2020

(54) AUTONOMOUS VEHICLE INDICATOR LIGHT SYSTEM

(71) Applicants: Juan Carlos Redick, Reno, NV (US); Dexter Bush, Reno, NV (US)

(72) Inventors: Juan Carlos Redick, Reno, NV (US); Dexter Bush, Reno, NV (US)

(21) Appl. No.: 16/541,032

(22) Filed: Aug. 14, 2019

Related U.S. Application Data
(60) Provisional application No. 62/711,094, filed on Jul. 27, 2018.

(51) Int. Cl. B60Q 1/50; B60Q 1/26; B60Q 9/00

(52) U.S. Cl. CPC B60Q 1/50; B60Q 9/00; B60Q 1/2696

(57) ABSTRACT

An autonomous vehicle indication system and method configured to provide an indication of a driving mode of an autonomous vehicle. The system comprises an autonomous vehicle, an autonomous vehicle indication application and an autonomous driving mode indicator light positioned on an exterior surface of the vehicle. The autonomous vehicle indication application includes a mode determination module an output module. The method comprises the steps of: providing an autonomous vehicle with an autonomous vehicle indication application installed on an on-board computer of the autonomous vehicle. Determining the mode of driving of the autonomous vehicle by the mode determination module and based on the output from the mode determination module, the output module turns on or turns off the autonomous driving mode indicator light.

### CLAIM OF PRIORITY

This application claims the priority of a provisional application filed by Dexter Bush in 2018 having the title “Vehicle Computer Controlled Function Indication Light” having a Legal Zoom® Order number of 53523393.

### BACKGROUND OF THE DISCLOSURE

### Technical Field of the Disclosure

The present disclosure relates generally to automated driving systems, and more particularly to an autonomous vehicle indication system to indicate the driving modes of an autonomous vehicle.

### Description of the Related Art

Recently autonomous vehicles are increasingly becoming popular due to its increased benefits. Autonomous vehicles provide an autonomous mode in which the operation of the vehicle is controlled by an application incorporated in an on-board computer and a manual mode in which the operation of the vehicle is controlled by a human. Many people have begun to own and operate vehicles that include computer controlled driving features ranging from lane and breaking assist features to self-driving. However, such vehicles sometimes need to switch from autonomous to manual mode or from manual to autonomous mode. While driving on the roads, many other drivers on the road are not aware that these features have been activated and the vehicle or functions of the vehicle are being controlled by the computer. The ability for a human to decide whether the vehicle is being operated by a human or a computer is almost impossible. Some types of alerts and indicators have been developed to overcome such situations.

One such currently available alert system provides a driving mode alert from self-driving vehicles that alerts a proximate entity of a current real-time driving mode of a vehicle. One or more processors determine a current real-time driving mode of a vehicle. The processor(s) generate a driving mode indicator that identifies the current real-time driving mode of the vehicle. An indicator emitter then broadcasts the driving mode indicator from the vehicle to the proximate entity, such that the driving mode indicator indicates the current real-time driving mode of the vehicle. However, in this system, communication is between two autonomous vehicles and the spacing between the two autonomous vehicles is adjusted. This system does not provide an alert to other vehicles operating in manual mode.

Another existing system provides a drive state of an autonomous vehicle that includes a human machine interface and an electronic controller electrically coupled to the human machine interface and which is configured to display a drive state indicator. The human machine interface provides an interface between the autonomous vehicle control system and the driver. However, in this system the drive state indicator displayed on the human machine interface can be seen only by the driver and cannot be seen by other vehicle operators nearby the autonomous vehicle.

Yet another method and system displays machine mode information to a remote operator of a plurality of machines that includes collecting video data, sensor information, alert information and operating mode data with respect to each of the machines. A machine display is then provided at a remote control center including one or more screen regions, a machine mode and alert indicator associated with each of the machines, denoting an operating mode of the associated machines. However, such alerts are shown in the machine display, and by looking at the machine display the person driving the vehicle feel confused and fails to relate the mode displayed in the machine display with the modes of the nearby vehicles.

Therefore, there is thus a need for an autonomous vehicle indication system that provides an indication of a driving mode of an autonomous vehicle. Such a system would provide other vehicle operators with a visual indication that the autonomous vehicle is in autonomous mode or manual mode. Such a needed system would provide an illuminated light when the vehicle is controlled by a computer. Such a system would provide indication to other nearby vehicles operating in manual mode. Such a needed system would provide an indicator that can be easily recognized by people nearby the autonomous vehicle. The present embodiment accomplishes these objectives.

### SUMMARY OF THE DISCLOSURE

To minimize the limitations found in the existing systems and methods, and to minimize other limitations that will be apparent upon the reading of the specifications, preferred embodiment of the present invention provides an autonomous vehicle indication system configured to provide an indication of a driving mode of an autonomous vehicle.

The autonomous vehicle indication system comprises an autonomous vehicle, an autonomous vehicle indication application installed in an on-board computer of the autonomous vehicle, at least one connector connected to the on-board computer of the autonomous vehicle and an autonomous driving mode indicator light attached to the at least one connector via an electric wire and conspicuously positioned on an exterior surface of the vehicle.

The autonomous vehicle having the autonomous driving system is controlled and driven by a set of applications installed in the autonomous on-board computer having a processor. The autonomous vehicle indication application is installed in the processor of the autonomous on-board computer and coupled with a memory unit. The autonomous vehicle indication application includes a mode determination module and an output module. The mode determination module is configured to identify the mode of driving of the autonomous vehicle. The mode determination module identifies whether the autonomous vehicle is driven in the automatic mode or manual mode. The mode determination module determines the mode of driving of the autonomous vehicle and provides the details of the mode to the output module. The output module turns on or off the autonomous driving mode indicator light positioned on the surface of the autonomous vehicle based on the mode of driving provided by the mode determination module. If the mode determined by the mode determination module is automatic, then the output module turns on the autonomous driving mode indicator light. If the mode determined by the mode determination module is manual, then the output module turns off the autonomous driving mode indicator light.

A method for determining the mode of driving of the autonomous vehicle utilizing the autonomous vehicle indication system comprises the steps of: providing an autonomous vehicle with an autonomous vehicle indication application installed on an on-board computer of the vehicle and an autonomous driving mode indicator light conspicuously positioned on an exterior surface of the vehicle. Determining the mode of operation of the autonomous vehicle by a mode determination module of the autonomous vehicle indication application. The mode determining module determines if the vehicle is in automatic mode or in manual mode. Based on the output from the mode determination module, an output module of the autonomous vehicle indication application turns on or turns off the autonomous driving mode indicator light. If a computer controlled function of the autonomous vehicle is activated, the mode determining module determines the mode to be automatic. Then the output module sends electricity through an at least one connector and down an electric wire connected with the autonomous driving mode indicator and turns it on.

A first objective of the present embodiment is to provide an autonomous vehicle indication system that provides an indication of a driving mode of an autonomous vehicle so that other drivers on the road and pedestrians can immediately know that the vehicle is being driven autonomously and take appropriate precautions.

A second objective of the present embodiment is to provide an autonomous vehicle indication system that provides other vehicle operators with a visual indication that the vehicle is in autonomous mode or manual mode.

A third objective of the present embodiment is to provide a system that provides an illuminated light when the vehicle is controlled by an on-board computer.

Another objective of the present embodiment is to provide an indicator that can be easily recognized by people nearby the autonomous vehicle.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a high level block diagram of an autonomous vehicle indication system that provides an indication of a mode of driving of the autonomous vehicle in accordance with the preferred embodiment of the present invention;

FIG. 2 illustrates a block diagram of the autonomous vehicle indication system that provides an indication of the mode of driving of the autonomous vehicle in accordance with the preferred embodiment of the present invention;

FIG. 3 illustrates a side perspective view of the autonomous vehicle installed with the autonomous vehicle indication application and with the autonomous driving mode indicator light turned on in accordance with the preferred embodiment of the present invention; and

FIG. 4 illustrates a flowchart of a method for determining the mode of driving of the autonomous vehicle utilizing the autonomous vehicle indication system in accordance with the preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term ‘about” means+/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

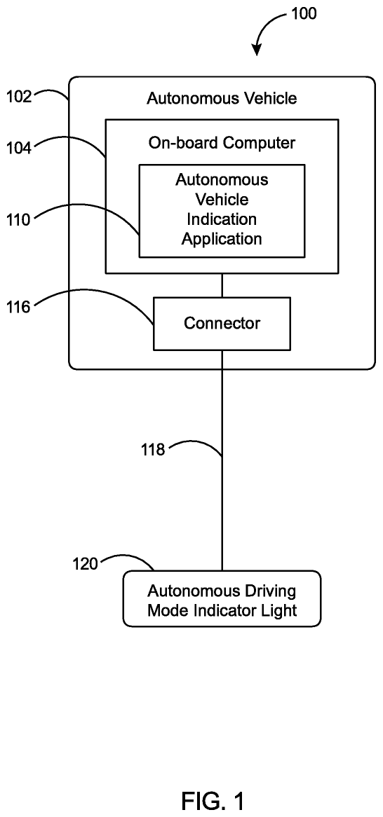

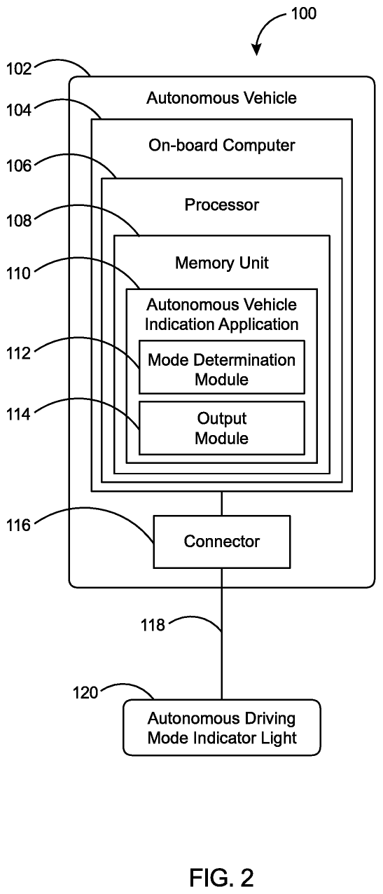

Referring to FIGS. 1 and 2, block diagrams of an autonomous vehicle indication system 100 configured to provide an indication of a mode of driving of an autonomous vehicle 102 are illustrated. The autonomous vehicle 102 can be driven in an automatic mode and a manual mode. In the automatic mode, the autonomous vehicle 102 is controlled and driven by a set of applications installed in the processor of the autonomous vehicle 102 and in the manual mode the autonomous vehicle 102 is controlled and driven by a human.

The present embodiment provides an autonomous vehicle indication system 100 to identify and indicate the mode in which the autonomous vehicle 102 is driven. The autonomous vehicle indication system 100 comprises an autonomous vehicle 102, an autonomous vehicle indication application 110 installed in an on-board computer 104 of the autonomous vehicle 102, at least one connector 116 connected to the on-board computer 104 of the autonomous vehicle 102 and an autonomous driving mode indicator light 120 attached to the at least one connector 116 via an electric wire 118 and conspicuously positioned on an exterior surface of the vehicle 102.

The autonomous vehicle 102 having the autonomous driving system is controlled and driven by a set of applications installed in an autonomous on-board computer 104 having a processor 106. The set of applications includes computer readable program instructions for carrying out operations of the autonomous vehicle 102.

The autonomous vehicle indication application 110 of the present embodiment is installed in the processor 106 of the autonomous on-board computer 104 and coupled with a memory unit 108. The autonomous vehicle indication application 110 is used to identify when the autonomous on-board computer controlled feature of the vehicle 102 is enabled. The autonomous vehicle indication application 110 includes a mode determination module 112 and an output module 114. The mode determination module 112 is configured to identify the mode of driving of the autonomous vehicle 102. The mode determination module 112 identifies whether the autonomous vehicle 102 is driven in the automatic mode or in the manual mode. In the automatic mode, the autonomous vehicle 102 is controlled by the set of applications installed in the autonomous on-board computer 104 and in the manual mode, humans drive the autonomous vehicle 102. The mode determination module 112 determines the mode of driving of the autonomous vehicle 102 and provides the details of the driving mode to the output module 114. The output module 114 illuminates the autonomous driving mode indicator light 120 positioned on the surface of the autonomous vehicle 102 based on the mode of driving provided by the mode determination module 112. If the mode determined by the mode determination module 112 is automatic, then the output module 114 turns on the autonomous driving mode indicator light 120. If the mode determined by the mode determination module 112 is manual, then the output module 114 turns off the autonomous driving mode indicator light 120. Thus, when the autonomous driving mode indicator light 120 is not illuminated, the system 100 indicates that the vehicle 102 is being operated by the human; and when the autonomous driving mode indicator light 120 is illuminated it indicates that autonomous functions of the vehicle 102 are enabled.

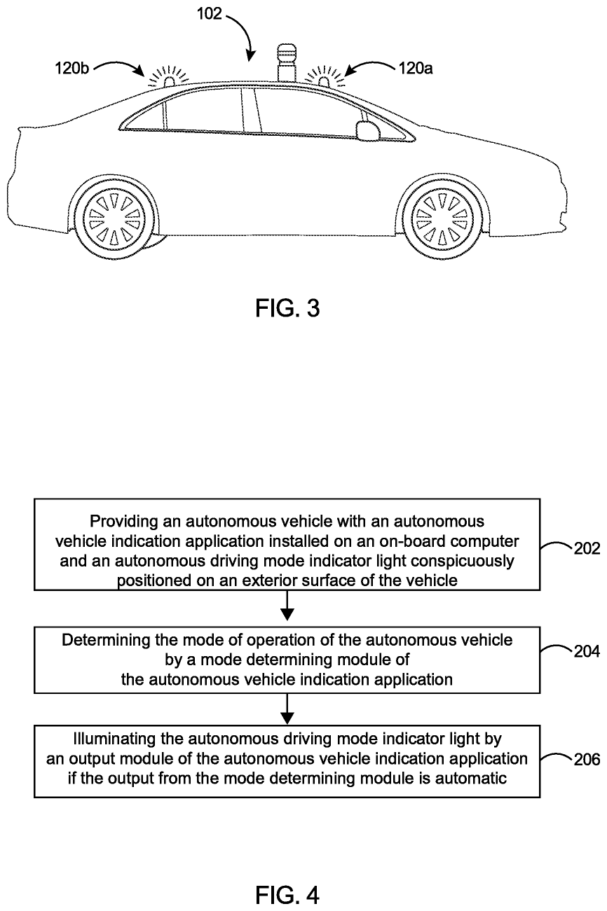

FIG. 3 illustrates a side perspective view of the autonomous vehicle 102 installed with the autonomous vehicle indication application 110 and with the autonomous driving mode indicator light 120 turned on in accordance with the preferred embodiment of the present invention. The autonomous vehicle indication application 110 is installed in the processor 106 of the autonomous on-board computer 104. The mode determination module 112 of the autonomous vehicle indication application 110 detects when the computer controlled driving feature of the vehicle 102 has been activated. The at least one connector 116 is hooked to the on-board computer 104 to connect the autonomous driving mode indicator light 120 with the on-board computer 104 by means of the electric wire 118. The electric wire 118 provides power to the autonomous driving mode indicator light 120 to illuminate it when the computer controlled features of the autonomous vehicle 102 are activated. The structure, size and shape of the at least one connector 116 and the autonomous driving mode indicator light 120 may vary based on the vehicle 102 and is designated by vehicle manufacturer. The location of the autonomous driving mode indicator light 120 is designated by manufacturer and approved by applicable government agencies.

The autonomous driving mode indicator light 120 is coupled to the autonomous driving system 100 such that it automatically turns on at all times while the vehicle 102 is being controlled autonomously and automatically turns off at all times while the vehicle 102 is not being controlled autonomously. Preferably, the autonomous driving mode indicator light 120 can be positioned on top of the vehicle 102 or on the back of the vehicle 102 as shown in FIG. 3. The autonomous driving mode indicator light 120 includes a flashing element (not shown). The autonomous driving mode indicator light 120 can have color, size, brightness, and positioning that are set in conformance with a predetermined legal requirement. Turning on and off of the autonomous driving mode indicator light 120 always allows other vehicle operators to be certain that computer controlled features are activated when the autonomous driving mode light indicator 120 is illuminated.

In one embodiment, the autonomous driving mode indicator light 120 includes a literal element (not shown). The literal element is adaptable to display words selected from the group consisting of: self-driving, autonomous, auto, driverless and auto-drive.

The present embodiment can be employed on top of every autonomous vehicle 102 to provide a visual indicator that the computer controlled features of the vehicle 102 are being activated. The visual indicator allows other drivers on the road to be cautious while driving around the autonomous vehicles, while being made aware visually of the added danger that could be posed by the computer controlled vehicle. Thus the present embodiment gives other vehicle operators on the road the ability to act and drive accordingly to the computer controlled vehicles around them on the road.

In one embodiment, the autonomous vehicle indication system 100 further includes a second autonomous driving mode indicator light 120b, such that a first autonomous driving mode indicator light 120a is positioned at the front of the autonomous vehicle 102 and the second autonomous driving mode indicator light 120b is positioned at the back of the autonomous vehicle 102. In one embodiment, the autonomous driving mode indicator light 120 comprises a first LED strip (not shown) and a second LED strip (not shown). The first LED strip being located above and adjacent to a front windshield of the vehicle, and the second LED strip being located above and adjacent to a rear windshield of the vehicle. The autonomous vehicle indication system 100 further includes a dashboard indicator light (not shown) that automatically turns on at all times while the autonomous vehicle 102 is being controlled autonomously and automatically turns off at all times while the vehicle 102 is not being controlled autonomously.

The processor 106 is an electronic circuit that executes computer programs. The memory unit 108 stores programs, applications, and data. For example, the mode determination module 112 and the output module 114 of the autonomous vehicle indication application 110 are stored on the memory unit 108 of the autonomous vehicle indication system 100. The memory unit 108 is, for example, a random access memory (RAM) or another type of dynamic storage device that stores information and instructions for execution by the processor. The memory unit 108 also stores temporary variables and other intermediate information used during execution of the instructions by the processor 106. The autonomous vehicle indication system 100 further comprises a read only memory (ROM) or another type of static storage device that stores static information and instructions for the processor 106. The autonomous vehicle indication system 100 that executes the autonomous vehicle indication application 110 communicates with the autonomous driving mode indicator light 120.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, processor cache, etc., and transmission media such as wires that constitute a system bus coupled to the processor 106, except for a transitory, propagating signal. The computer program product disclosed herein comprises one or more computer program codes for indicating the mode of driving of an autonomous vehicle 102 utilizing the autonomous vehicle indication system 100.

FIG. 4 illustrates a flowchart of a method for determining the mode of driving of the autonomous vehicle utilizing the autonomous vehicle indication system in accordance with the preferred embodiment of the present invention. The method comprises the steps of: providing a vehicle having an autonomous driving system with an autonomous vehicle indication application installed on the on-board computer of the vehicle and an autonomous driving mode indicator light conspicuously positioned on an exterior surface of the vehicle as indicated in block 202. The mode determining module determines the mode of operation of the autonomous vehicle as indicated in block 204. The mode determining module determines if the vehicle is in automatic mode or in manual mode. If a computer controlled function of the autonomous vehicle is activated, the mode determining module of the autonomous vehicle indication application determines the mode to be automatic. Based on the output from the mode determination module, the output module turns on or turns off the autonomous driving mode indicator light as indicated in block 206. If a computer controlled function of the autonomous vehicle is activated, the mode determining module determines the mode to be automatic. Then the output module sends electricity through the at least one connector down an electric wire to illuminate the autonomous driving mode indicator.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. An autonomous vehicle indication system comprising:
a. a vehicle, the vehicle having an autonomous driving system;
b. an indicator light conspicuously positioned on an exterior surface of the vehicle;
c. the indicator light is coupled to the autonomous driving system such that the indicator light automatically turns on at all times while the vehicle is being controlled autonomously and the indicator light automatically turns off at all times while the vehicle is not being controlled autonomously thereby allowing so that other drivers on the road and pedestrians to immediately know that the vehicle is being driven autonomously and take appropriate precautions.

2. The system of claim 1, wherein the indicator light is positioned on top of the vehicle.

3. The system of claim 1, wherein the indicator light is positioned on the back of the vehicle.

4. The system of claim 1, wherein the indicator light is positioned on a side of the vehicle.

5. The system of claim 1, wherein the indicator light includes a flashing element.

6. The system of claim 1, wherein the indicator light has a color, size, brightness, and positioning that are set in conformance with a predetermined legal requirement.

7. The system of claim 1, wherein the indicator light includes a literal element.

8. The system of claim 7, wherein the literal element is selected from the group consisting of “self-driving,” “autonomous,” “auto,” “driverless,” and “auto-drive.”

9. The system of claim 1, further including a second indicator light, wherein the first indicator light is positioned at the back of the vehicle and the second indicator light is positioned at the front of the vehicle.

10. The system of claim 1, wherein the indicator light comprises an LED strip.

11. The system of claim 1, wherein the indicator light comprises a first LED strip and a second LED strip, the first LED strip being located above and adjacent to a front windshield of the vehicle, and the second LED strip being located above and adjacent to a rear windshield of the vehicle.

12. The system of claim 1, further including a dashboard indicator light, the dashboard indicator light automatically turns on at all times while the vehicle is being controlled autonomously and the dashboard indicator light automatically turns off at all times while the vehicle is not being controlled autonomously.

13. The system of claim 12, wherein the dashboard indicator light appears on a dashboard monitor of the vehicle.

14. The system of claim 12, wherein the dashboard indicator light is located within a field of view of a driver of the vehicle.
